(19) United States
(12) Patent Application Publication
(10) Pub. No.: US 2026/0309100 A1
(43) Pub. Date: Oct. 8, 2026

(54) COMBUSTION SYSTEM AND CONTROL METHOD

(71) Applicant: IHI Corporation, Tokyo (JP)

(72) Inventors: Itaru SAKURAI, Tokyo (JP); Yuichi NASUNO, Tokyo (JP); Ryunosuke ITOKAZU, Tokyo (JP)

(73) Assignee: IHI Corporation, Tokyo (JP)

(21) Appl. No.: 19/567,783

(22) Filed: Mar. 16, 2026

(30) Foreign Application Priority Data
Apr. 3, 2025 (JP) 2025-061925

(51) Int. Cl. F02C 9/40; F02C 3/22; F02C 3/24; F02C 3/30

(52) U.S. Cl. CPC F02C 9/40; F02C 3/22; F02C 3/24; F02C 3/30; F05D 2220/76; F05D 2270/082; F05D 2270/303

(57) ABSTRACT

In order to suppress the decrease in energy efficiency, provided is a combustion system including: a combustor to which ammonia is to be supplied; an intake flow passage connected to the combustor; an exhaust flow passage connected to the combustor; a recirculation flow passage connecting the exhaust flow passage and the intake flow passage to each other; and a control device that controls a temperature of exhaust gas circulating from the exhaust flow passage to the intake flow passage through the recirculation flow passage.

### BACKGROUND

### 1. Technical Field

The present disclosure relates to a combustion system and a control method. The present application claims the benefit of priority to Japanese Patent Application No. 2025-061925 filed on Apr. 3, 2025, the contents of which are incorporated herein by reference.

### 2. Description of the Related Art

As a combustion system for combusting fuel in a combustor, a gas turbine system or the like has been used. In the combustion system such as the gas turbine system, for example, ammonia may be used as fuel, as disclosed in Patent Literature 1. With the use of ammonia as fuel, emission of carbon dioxide is suppressed.
Patent Literature 1: WO 2010/082360 A1

Here, when ammonia is used as fuel, a nitrogen oxide (hereinafter also referred to as “NOx”) is likely to be generated due to nitrogen atoms contained in ammonia. In addition, in a partial load operation in which the combustion system is operated with a smaller load than in a steady operation, in addition to the increase in NOx emission, energy efficiency, which is generation efficiency of energy obtained by combustion in a combustor, may decrease.

### SUMMARY

An object of the present disclosure is to provide a combustion system and a control method with which the decrease in energy efficiency can be suppressed.

In order to solve the above-mentioned problem, according to at least one embodiment of the present disclosure, there is provided a combustion system including: a combustor to which ammonia is to be supplied; an intake flow passage connected to the combustor; an exhaust flow passage connected to the combustor; a recirculation flow passage connecting the exhaust flow passage and the intake flow passage to each other; and a control device that controls a temperature of exhaust gas circulating from the exhaust flow passage to the intake flow passage through the recirculation flow passage.

The control device may control the temperature based on energy efficiency which is generation efficiency of energy obtained by combustion in the combustor.

The combustion system may further include: a gas turbine including a compressor provided in the intake flow passage, and a turbine provided in the exhaust flow passage; and a generator connected to the gas turbine, and the energy efficiency may be electric power generation efficiency of the combustion system.

The combustion system may further include a heat exchanger which is provided in the recirculation flow passage, and through which a refrigerant flow passage passes, and the control device may control the temperature by controlling a flow rate of refrigerant flowing through the refrigerant flow passage.

The combustion system may further include a denitration device provided in the exhaust flow passage.

The combustion system may further include a demister provided at a location of connection between the recirculation flow passage and the intake flow passage.

The control device may control a flow rate of the exhaust gas circulating from the exhaust flow passage to the intake flow passage through the recirculation flow passage, based on a parameter related to an emission amount of a nitrogen oxide.

In addition to the ammonia, fuel free of a nitrogen atom may be supplied to the combustor, and the control device may control a ratio between a supply amount of the ammonia to be supplied to the combustor and a supply amount of the fuel free of a nitrogen atom to be supplied to the combustor, based on a parameter related to an emission amount of a nitrogen oxide.

Liquid ammonia and gaseous ammonia may be supplied as the ammonia to the combustor, and the control device may control a ratio between a supply amount of the liquid ammonia to be supplied to the combustor and a supply amount of the gaseous ammonia to be supplied to the combustor, based on the parameter related to an emission amount of a nitrogen oxide.

In order to solve the above-mentioned problem, according to at least one embodiment of the present disclosure, there is provided a control method for a combustion system, the combustion system including: a combustor to which ammonia is to be supplied; an intake flow passage connected to the combustor; an exhaust flow passage connected to the combustor; and a recirculation flow passage connecting the exhaust flow passage and the intake flow passage to each other, the control method including controlling, by a control device, a temperature of exhaust gas circulating from the exhaust flow passage to the intake flow passage through the recirculation flow passage.

According to the at least one embodiment of the present disclosure, the decrease in energy efficiency can be suppressed.

### BRIEF DESCRIPTION OF THE DRAWINGS

FIG. 1 is a schematic view for illustrating a configuration of a combustion system according to at least one embodiment of the present disclosure.

FIG. 2 is a flowchart for illustrating an example of a flow of first processing performed by a control device in the at least one embodiment of the present disclosure.

FIG. 3 is a flowchart for illustrating an example of a flow of second processing performed by the control device in the at least one embodiment of the present disclosure.

FIG. 4 is a flowchart for illustrating an example of a flow of third processing performed by the control device in the at least one embodiment of the present disclosure.

FIG. 5 is a flowchart for illustrating an example of a flow of fourth processing performed by the control device in the at least one embodiment of the present disclosure.

### DESCRIPTION OF THE EMBODIMENTS

Now, with reference to the attached drawings, at least one embodiment of the present disclosure is described. The dimensions, materials, and other specific numerical values and the like represented in the at least one embodiment are merely examples used for facilitating the understanding of the disclosure, and do not limit the present disclosure unless otherwise particularly noted. Elements having substantially the same functions and configurations herein and in the drawings are denoted by the same reference symbols to omit redundant description thereof. Further, illustration of elements with no direct relationship to the present disclosure is omitted.

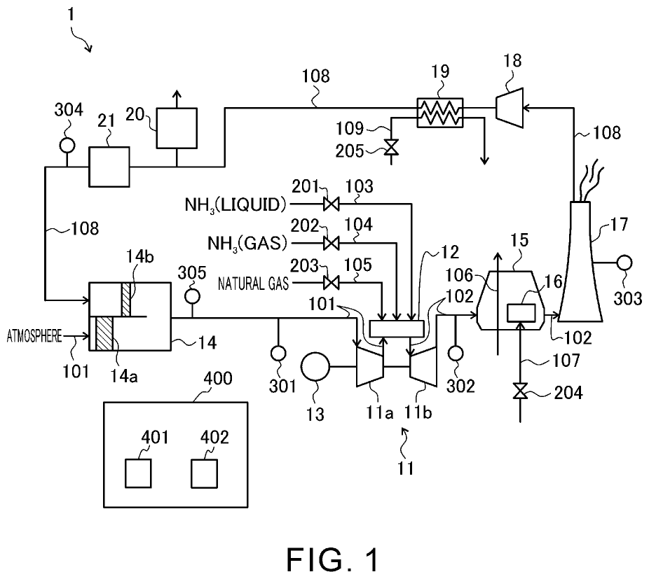

FIG. 1 is a schematic view for illustrating a configuration of a combustion system 1 according to the at least one embodiment. The combustion system 1 is a gas turbine system corresponding to an example of a combustion system that generates energy by combusting fuel. In particular, the combustion system 1 uses ammonia as fuel. This suppresses emission of carbon dioxide.

As illustrated in FIG. 1, the combustion system 1 includes a gas turbine 11, a combustor 12, a generator 13, a filter housing 14, a heat recovery steam generator 15, a denitration device 16, an exhaust tower 17, a fan 18, a heat exchanger 19, a first damper 20, and a second damper 21.

Further, the combustion system 1 includes, as flow passages through which fluid flows, an intake flow passage 101, an exhaust flow passage 102, a liquid ammonia flow passage 103, a gaseous ammonia flow passage 104, a natural gas flow passage 105, a water flow passage 106, a reducing agent flow passage 107, a recirculation flow passage 108, and a refrigerant flow passage 109.

Further, the combustion system 1 includes, as flow rate control valves that adjust flow rates of fluids flowing through the flow passages, a first flow rate control valve 201, a second flow rate control valve 202, a third flow rate control valve 203, a fourth flow rate control valve 204, and a fifth flow rate control valve 205.

Further, the combustion system 1 includes, as sensors, a first gas analyzer 301, a second gas analyzer 302, a third gas analyzer 303, a first thermometer 304, and a second thermometer 305.

Further, the combustion system 1 includes a control device 400 that controls each device included in the combustion system 1.

The gas turbine 11 includes a compressor 11a and a turbine 11b. The compressor 11a and the turbine 11b rotate integrally. The compressor 11a and the turbine 11b are connected to each other by a shaft.

The compressor 11a is provided in the intake flow passage 101 connected to the combustor 12. Air to be supplied to the combustor 12 flows through the intake flow passage 101. As described later, exhaust gas is sent from the recirculation flow passage 108 to the intake flow passage 101, and the exhaust gas may be supplied to the combustor 12 in addition to air.

The filter housing 14 is provided on the upstream side of the compressor 11a in the intake flow passage 101. The filter housing 14 is a housing provided with a filter that removes substances in gas. The filter housing 14 is provided with an air filter 14a and a demister 14b as such filters. The air filter 14a removes foreign matters from the atmosphere taken into the intake flow passage 101 and flowing through the intake flow passage 101. The demister 14b is described later. The atmosphere that has passed through the air filter 14a is sent to the combustor 12. The compressor 11a compresses air and discharges the air to the downstream side. The filter housing 14 may be further provided with a component (not shown) (for example, a heat exchanger).

The turbine 11b is provided in the exhaust flow passage 102 connected to the combustor 12. The exhaust gas discharged from the combustor 12 flows through the exhaust flow passage 102. The exhaust gas discharged from the combustor 12 passes through the turbine 11b and is sent to a downstream side of the turbine 11b in the exhaust flow passage 102. When the turbine 11b is rotated by the exhaust gas, rotational power is generated.

The generator 13 is connected to the gas turbine 11 (specifically, the compressor 11a and the turbine 11b). The rotational power generated by the gas turbine 11 is used for electric power generation by the generator 13.

Air compressed by the compressor 11a is supplied to the combustor 12 from the intake flow passage 101, and fuel is supplied to the combustor 12 from each of the liquid ammonia flow passage 103, the gaseous ammonia flow passage 104, and the natural gas flow passage 105. As described later, which type of fuel is to be supplied to the combustor 12 and a supply amount of each fuel to be supplied to the combustor 12 are controlled by the control device 400 depending on the situation.

The liquid ammonia flow passage 103 is a flow passage for supplying liquid ammonia to the combustor 12. The liquid ammonia flow passage 103 connects an ammonia supply source (not shown) and the combustor 12 to each other. Liquid ammonia sent from the ammonia supply source flows through the liquid ammonia flow passage 103. For example, liquid ammonia is stored in the ammonia supply source. In addition, the liquid ammonia is sent from the ammonia supply source to the liquid ammonia flow passage 103.

The first flow rate control valve 201 is provided in the liquid ammonia flow passage 103. The first flow rate control valve 201 adjusts a flow rate (that is, a supply amount) of liquid ammonia flowing through the liquid ammonia flow passage 103 to be supplied to the combustor 12. Specifically, the supply amount of liquid ammonia to be supplied to the combustor 12 is adjusted by adjusting an opening degree of the first flow rate control valve 201.

The gaseous ammonia flow passage 104 is a flow passage for supplying gaseous ammonia to the combustor 12. The gaseous ammonia flow passage 104 connects the ammonia supply source (not shown) and the combustor 12 to each other. Gaseous ammonia sent from the ammonia supply source flows through the gaseous ammonia flow passage 104. For example, liquid ammonia is stored in the ammonia supply source. In addition, liquid ammonia sent from the ammonia supply source is vaporized by a vaporizer, and gaseous ammonia thus generated is sent to the gaseous ammonia flow passage 104.

The second flow rate control valve 202 is provided in the gaseous ammonia flow passage 104. The second flow rate control valve 202 adjusts a flow rate (that is, a supply amount) of gaseous ammonia flowing through the gaseous ammonia flow passage 104 to be supplied to the combustor 12. Specifically, the supply amount of gaseous ammonia to be supplied to the combustor 12 is adjusted by adjusting an opening degree of the second flow rate control valve 202.

The natural gas flow passage 105 is a flow passage for supplying natural gas to the combustor 12. Natural gas corresponds to an example of fuel free of a nitrogen atom. However, the fuel free of a nitrogen atom to be supplied to the combustor 12 may be fuel other than natural gas. For example, the fuel free of a nitrogen atom to be supplied to the combustor 12 may be natural gas, hydrogen, or kerosene, or a combination thereof. The natural gas flow passage 105 connects a natural gas supply source (not shown) and the combustor 12 to each other. Natural gas sent from the natural gas supply source flows through the natural gas flow passage 105.

The third flow rate control valve 203 is provided in the natural gas flow passage 105. The third flow rate control valve 203 adjusts a flow rate (that is, a supply amount) of natural gas flowing through the natural gas flow passage 105 to be supplied to the combustor 12. Specifically, the supply amount of natural gas to be supplied to the combustor 12 is adjusted by adjusting an opening degree of the third flow rate control valve 203.

The heat recovery steam generator 15 is provided on the downstream side of the turbine 11b in the exhaust flow passage 102. The heat recovery steam generator 15 is provided with the water flow passage 106. The water flow passage 106 is a flow passage through which water flows. Water flowing through the water flow passage 106 is heated by the exhaust gas flowing through the exhaust flow passage 102, and is vaporized to become gas (that is, water vapor). For example, the water flow passage 106 is connected to a steam turbine (not shown). In addition, water vapor generated in the heat recovery steam generator 15 is sent to the steam turbine. As described above, a flow passage on an outlet side of the heat recovery steam generator 15 in the water flow passage 106 corresponds to a steam flow passage through which steam flows. In addition, the steam turbine is rotated by the water vapor, and rotational power is generated. For example, the rotational power generated by the steam turbine is used for electric power generation.

The denitration device 16 is provided on the downstream side of the turbine 11b in the exhaust flow passage 102. For example, the denitration device 16 is provided inside the heat recovery steam generator 15. However, the denitration device 16 may be provided outside the heat recovery steam generator 15 as long as the denitration device 16 is provided in the exhaust flow passage 102.

The reducing agent flow passage 107 is a flow passage for supplying a reducing agent to the denitration device 16. The reducing agent is, for example, gaseous ammonia, liquid ammonia, ammonia water, or urea water. However, the reducing agent is not particularly limited as long as the reducing agent can cause a denitration reaction to be described later. The reducing agent flow passage 107 connects a reducing agent supply source (not shown) and the denitration device 16 to each other. The reducing agent sent from the reducing agent supply source flows through the reducing agent flow passage 107.

The fourth flow rate control valve 204 is provided in the reducing agent flow passage 107. The fourth flow rate control valve 204 adjusts a flow rate (that is, a supply amount) of the reducing agent flowing through the reducing agent flow passage 107 to be supplied to the denitration device 16. Specifically, the supply amount of the reducing agent to be supplied to the denitration device 16 is adjusted by adjusting an opening degree of the fourth flow rate control valve 204.

As described above, the reducing agent is supplied to the denitration device 16. The denitration device 16 causes NOx in the exhaust gas flowing through the exhaust flow passage 102 to react with the reducing agent, to decompose NOx into nitrogen and water. This reaction is also called “denitration reaction.”

The exhaust tower 17 is provided on the downstream side of the heat recovery steam generator 15 in the exhaust flow passage 102. The exhaust gas discharged from the combustor 12 passes through the turbine 11b and the heat recovery steam generator 15, is sent to the exhaust tower 17, and is discharged from the exhaust tower 17. As described later, a part of the exhaust gas discharged from the exhaust tower 17 is sent to the recirculation flow passage 108.

The recirculation flow passage 108 is a flow passage for circulating exhaust gas from the exhaust flow passage 102 to the intake flow passage 101. The technology for recirculating exhaust gas in this manner is also called “exhaust gas recirculation (EGR)”. Further, the recirculation flow passage 108 is also called “EGR flow passage.” In the at least one embodiment of the present disclosure, exhaust gas circulating from the exhaust flow passage 102 to the intake flow passage 101 through the recirculation flow passage 108 is also referred to as “circulating gas.” The recirculation flow passage 108 connects the exhaust flow passage 102 and the intake flow passage 101 to each other. Specifically, the recirculation flow passage 108 connects the exhaust flow passage 102 and the intake flow passage 101 to each other while bypassing the combustor 12.

In the example of FIG. 1, the recirculation flow passage 108 connects the exhaust tower 17 and the filter housing 14 to each other. In the following, the exhaust tower 17 side with respect to the filter housing 14 in the recirculation flow passage 108 is referred to as “upstream side,” and the filter housing 14 side with respect to the exhaust tower 17 in the recirculation flow passage 108 is referred to as “downstream side.” However, a location of connection between the recirculation flow passage 108 and the exhaust flow passage 102 may be a location other than the exhaust tower 17. Further, a location of connection between the recirculation flow passage 108 and the intake flow passage 101 may be other than the filter housing 14.

The fan 18 is provided on the upstream side of the recirculation flow passage 108. The fan 18 pressurizes the circulating gas flowing through the recirculation flow passage 108 and sends the circulating gas to the downstream side.

The heat exchanger 19 is provided on the downstream side of the fan 18 in the recirculation flow passage 108. The refrigerant flow passage 109 passes through the heat exchanger 19. The refrigerant flow passage 109 is a flow passage through which refrigerant flows. The refrigerant flowing through the refrigerant flow passage 109 is, for example, water. In the heat exchanger 19, heat exchange is performed between the circulating gas flowing through the recirculation flow passage 108 and the refrigerant flowing through the refrigerant flow passage 109.

The fifth flow rate control valve 205 is provided in the refrigerant flow passage 109. The fifth flow rate control valve 205 adjusts a flow rate of the refrigerant flowing through the refrigerant flow passage 109. Specifically, the flow rate of the refrigerant flowing through the refrigerant flow passage 109 is adjusted by adjusting an opening degree of the fifth flow rate control valve 205.

The example in which the refrigerant flowing through the refrigerant flow passage 109 is water has been described above. However, the refrigerant flowing through the refrigerant flow passage 109 may be other than water. For example, the refrigerant flowing through the refrigerant flow passage 109 may be liquid ammonia. In this case, the liquid ammonia flowing through the refrigerant flow passage 109 may be heated by the circulating gas flowing through the recirculation flow passage 108 to an extent not to be vaporized, and supplied to the combustor 12 through the liquid ammonia flow passage 103. As another example, the liquid ammonia flowing through the refrigerant flow passage 109 may be heated and vaporized by the circulating gas flowing through the recirculation flow passage 108, and then supplied to the combustor 12 through the gaseous ammonia flow passage 104.

The first damper 20 is provided on the downstream side of the heat exchanger 19 in the recirculation flow passage 108. The first damper 20 adjusts a flow rate of fluid at an installation location thereof, for example, by adjusting a flow passage cross-sectional area at the installation location. Specifically, the first damper 20 is provided at a portion branching from the recirculation flow passage 108 and communicating with the atmosphere. The first damper 20 can adjust a flow rate of circulating gas discharged from the recirculation flow passage 108 to the atmosphere. In this manner, the first damper 20 can adjust a flow rate of circulating gas sent from the recirculation flow passage 108 to the intake flow passage 101. When a diameter of the flow passage at the installation location of the first damper 20 is small, a valve may be used instead of the first damper 20.

The second damper 21 is provided on the downstream side of the first damper 20 in the recirculation flow passage 108. The second damper 21 adjusts a flow rate of fluid at an installation location thereof, for example, by adjusting a flow passage cross-sectional area at the installation location. Specifically, the second damper 21 can adjust the flow rate of the circulating gas flowing through the recirculation flow passage 108. In this manner, the second damper 21 can adjust the flow rate of the circulating gas sent from the recirculation flow passage 108 to the intake flow passage 101. When a diameter of the flow passage at the installation location of the second damper 21 is small, a valve may be used instead of the second damper 21.

As described above, the filter housing 14 is provided at the location of connection between the recirculation flow passage 108 and the intake flow passage 101. In addition, the filter housing 14 is provided with the demister 14b. The demister 14b removes moisture contained in the circulating gas sent from the recirculation flow passage 108 to the intake flow passage 101. The circulating gas sent from the recirculation flow passage 108 to the filter housing 14 is sent to the intake flow passage 101 after moisture in the circulating gas is removed by the demister 14b.

The first gas analyzer 301 is provided on the downstream side of the filter housing 14 and on the upstream side of the compressor 11a in the intake flow passage 101. The first gas analyzer 301 measures a concentration of each component in the gas in the intake flow passage 101 (specifically, at an installation location of the first gas analyzer 301). For example, the first gas analyzer 301 measures a concentration of oxygen in the intake flow passage 101.

The second gas analyzer 302 is provided on the downstream side of the turbine 11b and on the upstream side of the heat recovery steam generator 15 in the exhaust flow passage 102. The second gas analyzer 302 measures a concentration of each component in the gas in the exhaust flow passage 102 (specifically, at an installation location of the second gas analyzer 302). For example, the second gas analyzer 302 measures a concentration of NOx and a concentration of oxygen in the exhaust flow passage 102.

The third gas analyzer 303 is provided inside the exhaust tower 17 or on the downstream side of the exhaust tower 17 in the exhaust flow passage 102. The third gas analyzer 303 measures a concentration of each component in the gas in the exhaust flow passage 102 (specifically, at an installation location of the third gas analyzer 303). For example, the third gas analyzer 303 measures a concentration of NOx and a concentration of oxygen in the exhaust flow passage 102.

The first thermometer 304 is provided on the downstream side of the second damper 21 in the recirculation flow passage 108. The first thermometer 304 measures a temperature of the gas in the recirculation flow passage 108 (specifically, at an installation location of the first thermometer 304).

The second thermometer 305 is provided on the downstream side of the filter housing 14 and on the upstream side of the compressor 11a in the intake flow passage 101. The second thermometer 305 measures a temperature of the gas in the intake flow passage 101 (specifically, at an installation location of the second thermometer 305).

The control device 400 includes, for example, a processor 401 and a memory 402. The processor 401 includes, for example, a central processing unit (CPU). The memory 402 includes, for example, a ROM having a program or the like stored therein, and a RAM serving as a work area. The function of the control device 400 is implemented by, for example, the processor 401 executing the program stored in the memory 402.

The control device 400 controls each device included in the combustion system 1. For example, the control device 400 can control the flow rate of the circulating gas by controlling the fan 18, the first damper 20, and the second damper 21. Further, the control device 400 can control the flow rate of each fluid by controlling the first flow rate control valve 201, the second flow rate control valve 202, the third flow rate control valve 203, the fourth flow rate control valve 204, and the fifth flow rate control valve 205. Further, the control device 400 can acquire detection results from the first gas analyzer 301, the second gas analyzer 302, the third gas analyzer 303, the first thermometer 304, and the second thermometer 305.

As described above, the combustion system 1 uses ammonia as fuel. This suppresses emission of carbon dioxide. Here, when ammonia is used as fuel, NOx is likely to be generated due to nitrogen atoms contained in ammonia. Further, in partial load operation in which the combustion system 1 is operated with a smaller load than in steady operation, in addition to an increase in NOx emission, energy efficiency, which is generation efficiency of energy obtained through combustion in the combustor 12, may decrease.

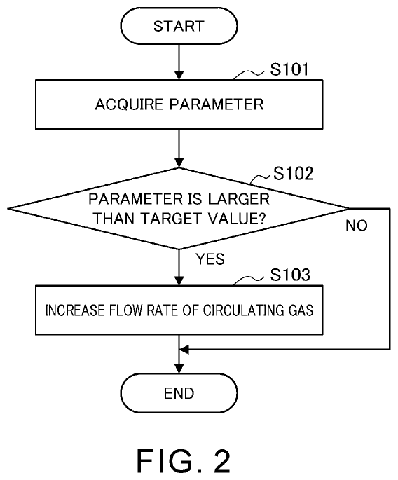

In view of the above, in the at least one embodiment, the above-mentioned various problems can be solved by devising, in particular, processing related to recirculation of circulating gas from the exhaust flow passage 102 to the intake flow passage 101 using the recirculation flow passage 108. In the following, with reference to FIG. 2 to FIG. 5, first processing, second processing, third processing, and fourth processing performed by the control device 400 are described.

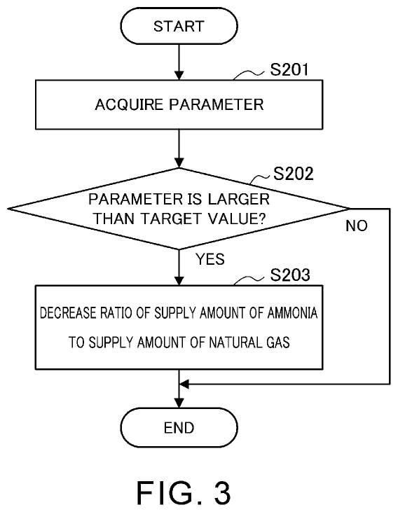

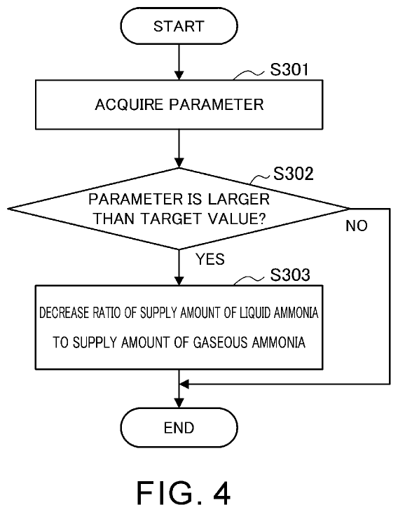

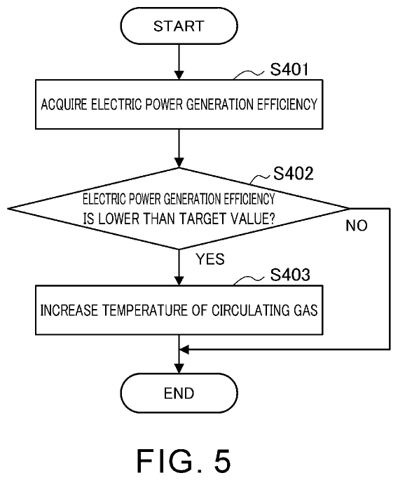

For example, the control device 400 repeatedly executes the processing flow of FIG. 2, the processing flow of FIG. 3, the processing flow of FIG. 4, and the processing flow of FIG. 5 sequentially and continuously. Each processing flow may be repeated, for example, at time intervals set in advance. However, a configuration in which the control device 400 does not perform a freely-selected part of the first processing, the second processing, the third processing, and the fourth processing described below may be adopted. For example, the control device 400 may perform only one type of processing among the first processing, the second processing, the third processing, and the fourth processing, or may perform any plurality of types of processing among the first processing, the second processing, the third processing, and the fourth processing.

FIG. 2 is a flowchart for illustrating an example of a flow of the first processing performed by the control device 400. When the processing flow illustrated in FIG. 2 is started, in Step S101, the control device 400 acquires a parameter related to an emission amount of NOx from the combustion system 1.

Specifically, the above-mentioned parameter has a correlation with the emission amount of NOx. In the following, an example in which the above-mentioned parameter has a positive correlation with the emission amount of NOx is described. That is, in the following, an example in which the above-mentioned parameter increases as the emission amount of NOx increases is described. However, the above-mentioned parameter may have a negative correlation with the emission amount of NOx. That is, the above-mentioned parameter may decrease as the emission amount of NOx increases.

The above-mentioned parameter may be, for example, the concentration of NOx in the exhaust flow passage 102. For example, the control device 400 acquires the concentration of NOx detected by the second gas analyzer 302 or the concentration of NOx detected by the third gas analyzer 303 as the above-mentioned parameter.

The above-mentioned parameter may be, for example, the concentration of oxygen in the intake flow passage 101. For example, the control device 400 acquires the concentration of oxygen detected by the first gas analyzer 301 as the above-mentioned parameter.

The above-mentioned parameter may be, for example, the concentration of oxygen in the exhaust flow passage 102. For example, the control device 400 acquires the concentration of oxygen detected by the second gas analyzer 302 or the concentration of oxygen detected by the third gas analyzer 303 as the above-mentioned parameter.

The above-mentioned parameter may be, for example, a supply amount of the reducing agent to be supplied to the denitration device 16. In this case, the control device 400 controls the supply amount of the reducing agent to be supplied to the denitration device 16 such that an amount of NOx reduced in the denitration device 16 becomes a predetermined value. Accordingly, the control device 400 can grasp the supply amount of the reducing agent to be supplied to the denitration device 16.

For example, the control device 400 acquires a value corresponding to a value obtained by subtracting the concentration of NOx detected by the second gas analyzer 302 from the concentration of NOx detected by the third gas analyzer 303, as the amount of NOx actually reduced in the denitration device 16. In addition, when the amount of NOx actually reduced in the denitration device 16 is smaller than a predetermined value, the control device 400 increases the opening degree of the fourth flow rate control valve 204 to increase the supply amount of the reducing agent to be supplied to the denitration device 16. In contrast, when the amount of NOx actually reduced in the denitration device 16 is larger than the predetermined value, the control device 400 decreases the opening degree of the fourth flow rate control valve 204 to decrease the supply amount of the reducing agent to be supplied to the denitration device 16. Accordingly, the control device 400 can acquire the supply amount of the reducing agent to be supplied to the denitration device 16, based on, for example, the opening degree of the fourth flow rate control valve 204.

The above-mentioned parameter may be, for example, output of the gas turbine 11. In this case, the control device 400 controls supply of fuel to the combustor 12 such that the output of the gas turbine 11 becomes a required value. Accordingly, the control device 400 can grasp the output of the gas turbine 11.

After Step S101, in Step S102, the control device 400 determines whether or not the above-mentioned parameter is larger than a target value.

The target value of the above-mentioned parameter is such a value that the emission amount of NOx from the combustion system 1 becomes a target emission amount. The target emission amount is a target value of the emission amount of NOx, and is, for example, set in advance. In the combustion system 1, there is a demand to make the emission amount of NOx equal to or less than the target emission amount.

Specifically, a target value is set for each type of the above-mentioned parameter. For example, a target value of the concentration of NOx in the exhaust flow passage 102, a target value of the concentration of oxygen in the intake flow passage 101, a target value of the concentration of oxygen in the exhaust flow passage 102, a target value of the supply amount of the reducing agent to be supplied to the denitration device 16, and a target value of the output of the gas turbine 11 are set separately.

A case in which the above-mentioned parameter is larger than the target value corresponds to a case in which the emission amount of NOx is larger than the target emission amount. In the first processing of FIG. 2, as described later, in such a case, the emission amount of NOx is reduced by increasing the flow rate of the circulating gas.

For example, the fact that the concentration of NOx in the exhaust flow passage 102 is larger than the target value directly indicates that the emission amount of NOx is larger than the target emission amount.

Further, when the amount of oxygen to be supplied to the combustor 12 is large, nitrogen atoms and oxygen atoms are likely to react to generate NOx during combustion in the combustor 12. Accordingly, the fact that the concentration of oxygen in the intake flow passage 101 or the concentration of oxygen in the exhaust flow passage 102 is larger than the target value also indicates that the emission amount of NOx is larger than the target emission amount.

Further, as described above, as the amount of NOx reduced in the denitration device 16 increases, the supply amount of the reducing agent to be supplied to the denitration device 16 also increases. Accordingly, the fact that the supply amount of the reducing agent to be supplied to the denitration device 16 is larger than the target value also indicates that the emission amount of NOx is larger than the target emission amount.

Further, when the output of the gas turbine 11 is large, the supply amount of fuel to the combustor 12 is large, and hence NOx is likely to be generated by combustion in the combustor 12. Accordingly, the fact that the output of the gas turbine 11 is larger than the target value also indicates that the emission amount of NOx is larger than the target emission amount.

When it is not determined that the above-mentioned parameter is larger than the target value (NO in Step S102), the processing flow illustrated in FIG. 2 is ended. In contrast, when it is determined that the above-mentioned parameter is larger than the target value (YES in Step S102), the process proceeds to Step S103.

When the determination of “YES” is made in Step S102, in Step S103, the control device 400 increases the flow rate of the circulating gas, and the processing flow illustrated in FIG. 2 is ended.

For example, in Step S103, the control device 400 increases the flow rate of the circulating gas by increasing the rotation speed of the fan 18, decreasing the opening degree of the first damper 20, or increasing the opening degree of the second damper 21. However, the control device 400 may increase the flow rate of the circulating gas by controlling any plurality of types of devices among the fan 18, the first damper 20, and the second damper 21.

As described above, in the first processing, when the above-mentioned parameter is larger than the target value and the emission amount of NOx is larger than the target emission amount, the control device 400 increases the flow rate of the circulating gas. In this manner, a ratio of circulating gas having a lower oxygen concentration than that of the atmosphere in the gas supplied to the combustor 12 can be increased, and hence the amount of oxygen to be supplied to the combustor 12 can be reduced. Accordingly, the amount of NOx generated as a result of combustion in the combustor 12 can be reduced, and hence emission of NOx can be suppressed. Further, as a result, the above-mentioned parameter transitions to approach the target value. In this manner, the control device 400 can suppress emission of NOx by controlling the flow rate of the circulating gas such that the above-mentioned parameter approaches the target value.

As described above, in the above-mentioned first processing, the control device 400 controls the flow rate of the exhaust gas circulating from the exhaust flow passage 102 to the intake flow passage 101 through the recirculation flow passage 108 (that is, the circulating gas), based on the parameter related to the emission amount of NOx. In this manner, as described above, the amount of NOx generated as a result of combustion in the combustor 12 can be reduced, and hence emission of NOx can be suppressed.

Here, the combustion system 1 includes the denitration device 16 provided in the exhaust flow passage 102. In this manner, as the amount of NOx discharged from the combustor 12 is reduced, the amount of NOx required to be reduced in the denitration device 16 can also be reduced. Accordingly, the denitration device 16 can be downsized. As another example, the supply amount of the reducing agent to be supplied to the denitration device 16 can be reduced.

In the above-mentioned first processing, the above-mentioned parameter includes, for example, the concentration of NOx in the exhaust flow passage 102. In this manner, the flow rate of the circulating gas is appropriately controlled in consideration of necessity to increase the flow rate of the circulating gas in order to reduce the emission amount of NOx.

Further, in the above-mentioned first processing, the above-mentioned parameter includes, for example, the concentration of oxygen in the intake flow passage 101. In this manner, the flow rate of the circulating gas is appropriately controlled in consideration of necessity to increase the flow rate of the circulating gas in order to reduce the emission amount of NOx.

Further, in the above-mentioned first processing, the above-mentioned parameter includes, for example, the concentration of oxygen in the exhaust flow passage 102. In this manner, the flow rate of the circulating gas is appropriately controlled in consideration of necessity to increase the flow rate of the circulating gas in order to reduce the emission amount of NOx.

Further, in the above-mentioned first processing, the above-mentioned parameter includes, for example, the supply amount of the reducing agent to be supplied to the denitration device 16. In this manner, the flow rate of the circulating gas is appropriately controlled in consideration of necessity to increase the flow rate of the circulating gas in order to reduce the emission amount of NOx.

Further, in the above-mentioned first processing, the above-mentioned parameter includes, for example, the output of the gas turbine 11. In this manner, the flow rate of the circulating gas is appropriately controlled in consideration of necessity to increase the flow rate of the circulating gas in order to reduce the emission amount of NOx.

In the above, the concentration of NOx in the exhaust flow passage 102, the concentration of oxygen in the intake flow passage 101, the concentration of oxygen in the exhaust flow passage 102, the supply amount of the reducing agent to be supplied to the denitration device 16, and the output of the gas turbine 11 have been given as examples of the above-mentioned parameter. However, the control device 400 may use all of those types of parameters as the above-mentioned parameter, or may use only any part of all of those types of parameters as the above-mentioned parameter.

Further, the combustion system 1 includes the demister 14b provided at the location of connection between the recirculation flow passage 108 and the intake flow passage 101. In this manner, moisture contained in the circulating gas sent from the recirculation flow passage 108 to the intake flow passage 101 can be removed. Accordingly, unnecessary supply of moisture to the intake flow passage 101 or the combustor 12 can be suppressed. In this manner, for example, when water vapor and ammonia gas in intake air sent to the gas turbine 11 change to a liquid phase, liquid droplets thereof can be removed by the demister 14b.

In the above, the example in which the control device 400 increases the flow rate of the circulating gas when the above-mentioned parameter is larger than the target value has been described. However, the control device 400 may decrease the flow rate of the circulating gas when the above-mentioned parameter is smaller than the target value. Further, the control device 400 may control the flow rate of the circulating gas to a value corresponding to the above-mentioned parameter regardless of comparison between the above-mentioned parameter and the target value.

FIG. 3 is a flowchart for illustrating an example of a flow of the second processing performed by the control device 400. When the processing flow illustrated in FIG. 3 is started, in Step S201, the control device 400 acquires a parameter related to the emission amount of NOx from the combustion system 1. The processing step of Step S201 is similar to the processing step of Step S101 described above.

After Step S201, in Step S202, the control device 400 determines whether or not the above-mentioned parameter is larger than the target value. The processing step of Step S202 is similar to the processing step of Step S102 described above.

When it is not determined that the above-mentioned parameter is larger than the target value (NO in Step S202), the processing flow illustrated in FIG. 3 is ended. In contrast, when it is determined that the above-mentioned parameter is larger than the target value (YES in Step S202), the process proceeds to Step S203.

When the determination of “YES” is made in Step S202, in Step S203, the control device 400 decreases a ratio of the supply amount of ammonia to the combustor 12 to the supply amount of natural gas to the combustor 12, and the processing flow illustrated in FIG. 3 is ended.

For example, in Step S203, the control device 400 decreases the ratio of the supply amount of ammonia to the supply amount of natural gas by decreasing the opening degree of at least one of the first flow rate control valve 201 or the second flow rate control valve 202 and increasing the opening degree of the third flow rate control valve 203. For example, the control device 400 may gradually change the ratio of the supply amount of ammonia to the supply amount of natural gas along with the elapse of time. Control of a ratio between the supply amount of liquid ammonia to be supplied to the combustor 12 and the supply amount of gaseous ammonia to be supplied to the combustor 12 is described later.

As described above, in the second processing, when the above-mentioned parameter is larger than the target value and the emission amount of NOx is larger than the target emission amount, the control device 400 decreases the ratio of the supply amount of ammonia to the supply amount of natural gas. In this manner, the ratio of ammonia in the fuel supplied to the combustor 12 can be reduced. Accordingly, the amount of NOx generated as a result of combustion in the combustor 12 can be reduced, and hence emission of NOx can be suppressed. Further, as a result, the above-mentioned parameter transitions to approach the target value. In this manner, the control device 400 can suppress emission of NOx by controlling the ratio of the supply amount of ammonia to the supply amount of natural gas such that the above-mentioned parameter approaches the target value.

As described above, in the above-mentioned second processing, the control device 400 controls the ratio between the supply amount of ammonia to be supplied to the combustor 12 and the supply amount of fuel free of a nitrogen atom (in the above-mentioned example, natural gas) to be supplied to the combustor 12, based on the above-mentioned parameter. In this manner, as described above, the amount of NOx generated as a result of combustion in the combustor 12 can be reduced, and hence emission of NOx can be suppressed.

In the above, the example in which the control device 400 decreases the ratio of the supply amount of ammonia to the supply amount of natural gas when the above-mentioned parameter is larger than the target value has been described. However, the control device 400 may increase the ratio of the supply amount of ammonia to the supply amount of natural gas when the above-mentioned parameter is smaller than the target value. Further, the control device 400 may control the ratio of the supply amount of ammonia to the supply amount of natural gas to a value corresponding to the above-mentioned parameter regardless of comparison between the above-mentioned parameter and the target value.

FIG. 4 is a flowchart for illustrating an example of a flow of the third processing performed by the control device 400. When the processing flow illustrated in FIG. 4 is started, in Step S301, the control device 400 acquires a parameter related to the emission amount of NOx from the combustion system 1. The processing step of Step S301 is similar to the processing step of Step S101 described above.

After Step S301, in Step S302, the control device 400 determines whether or not the above-mentioned parameter is larger than the target value. The processing step of Step S302 is similar to the processing step of Step S102 described above.

When it is not determined that the above-mentioned parameter is larger than the target value (NO in Step S302), the processing flow illustrated in FIG. 4 is ended. In contrast, when it is determined that the above-mentioned parameter is larger than the target value (YES in Step S302), the process proceeds to Step S303.

When the determination of “YES” is made in Step S302, in Step S303, the control device 400 decreases a ratio of the supply amount of liquid ammonia to the combustor 12 to the supply amount of gaseous ammonia to the combustor 12, and the processing flow illustrated in FIG. 4 is ended.

For example, in Step S303, the control device 400 decreases the ratio of the supply amount of liquid ammonia to the supply amount of gaseous ammonia by decreasing the opening degree of the first flow rate control valve 201 and increasing the opening degree of the second flow rate control valve 202. For example, the control device 400 may gradually change the ratio of the supply amount of liquid ammonia to the supply amount of gaseous ammonia along with the elapse of time. The control device 400 may supply only gaseous ammonia out of gaseous ammonia and liquid ammonia to the combustor 12, may supply only liquid ammonia to the combustor 12, or may supply both of gaseous ammonia and liquid ammonia to the combustor 12, depending on the situation.

As described above, in the third processing, when the above-mentioned parameter is larger than the target value and the emission amount of NOx is larger than the target emission amount, the control device 400 decreases the ratio of the supply amount of liquid ammonia to the supply amount of gaseous ammonia. In this case, liquid ammonia supplied to the combustor 12 evaporates and vaporizes in the combustor 12 and then burns. Accordingly, when liquid ammonia is supplied to the combustor 12, NOx is more likely to be generated due to reasons such as that energy required for combustion increases and that time until combustion starts becomes longer, as compared to a case in which gaseous ammonia is supplied to the combustor 12. Accordingly, with the ratio of the supply amount of liquid ammonia to the supply amount of gaseous ammonia being decreased, the amount of NOx generated as a result of combustion in the combustor 12 can be reduced, and hence emission of NOx can be suppressed. Further, as a result, the above-mentioned parameter transitions to approach the target value. In this manner, the control device 400 can suppress emission of NOx by controlling the ratio of the supply amount of liquid ammonia to the supply amount of gaseous ammonia such that the above-mentioned parameter approaches the target value.

As described above, in the above-mentioned third processing, the control device 400 controls the ratio between the supply amount of liquid ammonia to be supplied to the combustor 12 and the supply amount of gaseous ammonia to be supplied to the combustor 12, based on the above-mentioned parameter. In this manner, as described above, the amount of NOx generated as a result of combustion in the combustor 12 can be reduced, and hence emission of NOx can be suppressed.

In the above, the example in which the control device 400 decreases the ratio of the supply amount of liquid ammonia to the supply amount of gaseous ammonia when the above-mentioned parameter is larger than the target value has been described. However, the control device 400 may increase the ratio of the supply amount of liquid ammonia to the supply amount of gaseous ammonia when the above-mentioned parameter is smaller than the target value. Further, the control device 400 may control the ratio of the supply amount of liquid ammonia to the supply amount of gaseous ammonia to a value corresponding to the above-mentioned parameter regardless of comparison between the above-mentioned parameter and the target value.

As described above, the control device 400 may perform both of the second processing described with reference to FIG. 3 and the third processing described with reference to FIG. 4 as processing related to control of the supply amount of fuel to the combustor 12. That is, the control device 400 may control the ratio between the supply amount of liquid ammonia to be supplied to the combustor 12 and the supply amount of gaseous ammonia to be supplied to the combustor 12 based on the above-mentioned parameter, while controlling the ratio between the supply amount of ammonia to be supplied to the combustor 12 and the supply amount of fuel free of a nitrogen atom (in the above-mentioned example, natural gas) to be supplied to the combustor 12 based on the above-mentioned parameter.

FIG. 5 is a flowchart for illustrating an example of a flow of the fourth processing performed by the control device 400. When the processing flow illustrated in FIG. 5 is started, in Step S401, the control device 400 acquires electric power generation efficiency of the combustion system 1.

For example, the control device 400 calculates and acquires the electric power generation efficiency of the combustion system 1 based on an amount of fuel input to the gas turbine 11 and an amount of generated electric power output from the generator 13. The above-mentioned electric power generation efficiency corresponds to an example of energy efficiency which is generation efficiency of energy obtained by combustion in the combustor 12. For example, in the above, the example in which the gas turbine 11 is connected to the generator 13 has been described. However, a configuration in which the gas turbine 11 is not connected to the generator 13 and energy generated by the gas turbine 11 is used for a purpose other than electric power generation may be adopted. In this case, the above-mentioned energy efficiency is a parameter other than electric power generation efficiency.

After Step S401, in Step S402, the control device 400 determines whether or not the electric power generation efficiency is lower than a target value.

The above-mentioned target value of the electric power generation efficiency is, for example, set in advance. In the fourth processing of FIG. 5, the electric power generation efficiency is controlled to be equal to or higher than the target value such that a decrease in electric power generation efficiency is suppressed. Specifically, as described later, when the electric power generation efficiency is lower than the target value, the decrease in electric power generation efficiency is suppressed by increasing the temperature of the circulating gas.

When it is not determined that the electric power generation efficiency is lower than the target value (NO in Step S402), the processing flow illustrated in FIG. 5 is ended. In contrast, when it is determined that the electric power generation efficiency is lower than the target value (YES in Step S402), the process proceeds to Step S403.

When the determination of “YES” is made in Step S402, in Step S403, the control device 400 increases the temperature of the circulating gas, and the processing flow illustrated in FIG. 5 is ended.

For example, in Step S403, the control device 400 increases the temperature of the circulating gas by decreasing the opening degree of the fifth flow rate control valve 205 to decrease the flow rate of the refrigerant flowing through the refrigerant flow passage 109. The control device 400 may increase the temperature of the circulating gas such that, for example, the temperature of the circulating gas becomes a desired target value. In this case, the control device 400 may use, for example, the temperature detected by the first thermometer 304 or the temperature detected by the second thermometer 305 as the temperature of the circulating gas to be controlled.

As described above, in the fourth processing, when the electric power generation efficiency is lower than the target value, the control device 400 increases the temperature of the circulating gas. In this manner, the temperature of the gas to be supplied to the combustor 12 can be increased, and hence a combustion environment in the combustor 12 can be made closer to that in steady operation even in partial load operation. Accordingly, the decrease in electric power generation efficiency can be suppressed. In this manner, the control device 400 can suppress the decrease in electric power generation efficiency by controlling the temperature of the circulating gas such that the electric power generation efficiency approaches the target value.

As described above, in the above-mentioned fourth processing, the control device 400 controls the temperature of the exhaust gas circulating from the exhaust flow passage 102 to the intake flow passage 101 through the recirculation flow passage 108. In this manner, as described above, the combustion environment in the combustor 12 can be made closer to that in steady operation even in partial load operation, and hence a decrease in energy efficiency can be suppressed.

Further, in the above-mentioned fourth processing, the control device 400 controls the above-mentioned temperature based on energy efficiency (in the above-mentioned example, electric power generation efficiency) which is generation efficiency of energy obtained by combustion in the combustor 12. In this manner, the decrease in energy efficiency is appropriately suppressed.

The control device 400 may control the above-mentioned temperature based on information other than energy efficiency. For example, the control device 400 may control the above-mentioned temperature based on information substantially convertible into energy efficiency. Also in this case, the decrease in energy efficiency can be suppressed.

Further, in the above-mentioned fourth processing, the control device 400 controls the above-mentioned temperature by controlling the flow rate of the refrigerant flowing through the refrigerant flow passage 109 passing through the heat exchanger 19 provided in the recirculation flow passage 108. In this manner, the above-mentioned temperature is appropriately controlled.

The control device 400 may control the above-mentioned temperature by a method other than the method of controlling the flow rate of the refrigerant flowing through the refrigerant flow passage 109. For example, the control device 400 may control the above-mentioned temperature through use of a device that directly injects refrigerant into the recirculation flow passage 108.

In the above, the example in which the control device 400 increases the temperature of the circulating gas when the electric power generation efficiency is lower than the target value has been described. However, the control device 400 may decrease the temperature of the circulating gas when the electric power generation efficiency is higher than the target value. Further, the control device 400 may control the temperature of the circulating gas to a value corresponding to the current electric power generation efficiency regardless of comparison between the electric power generation efficiency and the target value.

The at least one embodiment of the present disclosure has been described above with reference to the attached drawings, but, needless to say, the present disclosure is not limited to the at least one embodiment. It is apparent that those skilled in the art may arrive at various alterations and modifications within the scope of the appended claims, and those examples are construed as naturally falling within the technical scope of the present disclosure.

In the above, the configuration of the combustion system 1 has been described with reference to FIG. 1. However, some of the components may be omitted from the combustion system 1, or components may be added to the combustion system 1. For example, a device that directly injects water or water vapor into the combustor 12 or into a flow passage on the upstream side of the combustor 12 may be added to the combustion system 1. Those devices are provided, for example, to suppress emission of NOx.

Further, in the above, description of equipment provided in association with the combustion system 1 is omitted. However, equipment provided in association with the combustion system 1 may be added. For example, the combustion system 1 may be used as a part of a cogeneration system, or may be used as a part of a combined cycle.

Further, in the above, the example in which the fuel free of a nitrogen atom (in the above-mentioned example, natural gas) is supplied to the combustor 12, in addition to ammonia, in the combustion system 1 has been described. However, a configuration in which the fuel free of a nitrogen atom is not supplied to the combustor 12 may be adopted.

Further, in the above, the example in which liquid ammonia and gaseous ammonia are supplied as ammonia to the combustor 12 in the combustion system 1 has been described. However, only one of liquid ammonia or gaseous ammonia may be supplied as ammonia to the combustor 12.

With the at least one embodiment of the present disclosure, the use of ammonia leading to reduction in CO₂ emission can be promoted, and hence, for example, it is possible to contribute to Goal 7 “Ensure access to affordable, reliable, sustainable and modern energy for all” and Goal 13 “Take urgent action to combat climate change and its impacts” of the Sustainable Development Goals (SDGs).

What is claimed is:

1. A combustion system, comprising:
a combustor to which ammonia is to be supplied;
an intake flow passage connected to the combustor;
an exhaust flow passage connected to the combustor;
a recirculation flow passage connecting the exhaust flow passage and the intake flow passage to each other; and
a control device that controls a temperature of exhaust gas circulating from the exhaust flow passage to the intake flow passage through the recirculation flow passage.

2. The combustion system according to claim 1, wherein the control device controls the temperature based on energy efficiency which is generation efficiency of energy obtained by combustion in the combustor.

3. The combustion system according to claim 2, further comprising:
a gas turbine including a compressor provided in the intake flow passage, and a turbine provided in the exhaust flow passage; and
a generator connected to the gas turbine,
wherein the energy efficiency is electric power generation efficiency of the combustion system.

4. The combustion system according to claim 1, further comprising a heat exchanger which is provided in the recirculation flow passage, and through which a refrigerant flow passage passes,
wherein the control device controls the temperature by controlling a flow rate of refrigerant flowing through the refrigerant flow passage.

5. The combustion system according to claim 1, further comprising a denitration device provided in the exhaust flow passage.

6. The combustion system according to claim 1, further comprising a demister provided at a location of connection between the recirculation flow passage and the intake flow passage.

7. The combustion system according to claim 1, wherein the control device controls a flow rate of the exhaust gas circulating from the exhaust flow passage to the intake flow passage through the recirculation flow passage, based on a parameter related to an emission amount of a nitrogen oxide.

8. The combustion system according to claim 1,
wherein, in addition to the ammonia, fuel free of a nitrogen atom is to be supplied to the combustor, and
wherein the control device controls a ratio between a supply amount of the ammonia to be supplied to the combustor and a supply amount of the fuel free of a nitrogen atom to be supplied to the combustor, based on a parameter related to an emission amount of a nitrogen oxide.

9. The combustion system according to claim 1,
wherein liquid ammonia and gaseous ammonia are to be supplied as the ammonia to the combustor, and
wherein the control device controls a ratio between a supply amount of the liquid ammonia to be supplied to the combustor and a supply amount of the gaseous ammonia to be supplied to the combustor, based on a parameter related to an emission amount of a nitrogen oxide.

10. A control method for a combustion system,
the combustion system including:
a combustor to which ammonia is to be supplied;
an intake flow passage connected to the combustor;
an exhaust flow passage connected to the combustor; and
a recirculation flow passage connecting the exhaust flow passage and the intake flow passage to each other,
the control method comprising controlling, by a control device, a temperature of exhaust gas circulating from the exhaust flow passage to the intake flow passage through the recirculation flow passage.
